(19) United States
(12) Patent Application Publication
(10) Pub. No.: US 2011/0202582 A1
(43) Pub. Date: Aug. 18, 2011

(54) METHOD AND APPARATUS FOR MANAGING TAG OF MULTIMEDIA CONTENT

(75) Inventors: Ho-joong KIM, Seongnam-si (KR); Sang-kwon LEE, Suwon-si (KR); Hyok-sung CHOI, Seoul (KR); Seong-kook SHIN, Suwon-si (KR); Se-jun HAN, Daejeon Metropolitan city (KR); Hee-seok YU, Suwon-si (KR)

(73) Assignee: SAMSUNG ELECTRONICS CO., LTD., Suwon-si (KR)

(21) Appl. No.: 12/880,810

(22) Filed: Sep. 13, 2010

(30) Foreign Application Priority Data
Feb. 18, 2010 (KR) 10-2010-0014731

(51) Int. Cl. G06F 17/30; G06F 15/16

(52) U.S. Cl. 707/827; 709/206; 707/E17.01

(57) ABSTRACT

Provided are a method and apparatus for managing, in a mobile device, a tag for multimedia content. The method includes: photographing the multimedia content that is identified by a content identifier (ID); obtaining additional information regarding the multimedia content; transmitting, to a tag providing server, a tag request message including a device ID of the mobile device, the content ID, and the additional information; and receiving, from the tag providing server, a tag response message including a recommendation tag list.

### CROSS-REFERENCE TO RELATED PATENT APPLICATION

This application claims priority from Korean Patent Application No. 10-2010-0014731, filed on Feb. 18, 2010 in the Korean Intellectual Property Office, the disclosure of which is incorporated herein in its entirety by reference.

### BACKGROUND

1. Field

Methods and apparatuses consistent with exemplary embodiments relate to managing a tag of multimedia contents, and more particularly, to managing a tag of multimedia contents, wherein a tag providing server provides a recommendation tag list to a mobile device based on additional information regarding multimedia contents, received from the mobile device, and the recommendation tag list is renewed based on a tag that is selected or input by using the mobile device.

2. Description of the Related Art

A tag is input to multimedia contents using, for example, a mobile tagging method. In the mobile tagging method, a user obtains information about an object by searching a resource such as an encyclopedia or the Internet while referring to a photographed image or by using global positioning system (GPS) information of a device. The user inputs the information relevant to the object as a tag by using an input unit such as a keypad to manage images and tags.

Alternatively, in a geotagging method, GPS coordinate information that is obtained using a GPS device attached to a camera is used as a tag. For example, GPS information may be combined with an image as an exchangeable image file format (EXIF) property.

Alternatively, in a contents parsing method, information that is obtained by parsing contents is used as a tag.

### SUMMARY

One or more exemplary embodiments provide a method and apparatus for managing a tag of multimedia contents, wherein a tag providing server provides a recommendation tag list to a mobile device based on additional information regarding the multimedia contents, received from the mobile device, and the recommendation tag list is renewed based on a tag that is selected or input by using the mobile device.

One or more exemplary embodiments also provide a computer readable recording medium for executing the method.

According to an aspect of an exemplary embodiment, there is provided a method of managing a tag, in a mobile device, the method including: photographing multimedia content that is identified by a content identifier (ID); obtaining additional information regarding the multimedia content; transmitting a tag request message including a device ID, the content ID, and the additional information to a tag providing server; and receiving a tag response message including a recommendation tag list from the tag providing server.

The additional information may include at least one of photographing time, position information, angle of view, focal distance, direction, altitude, acceleration, inclination, and point of interest (POI) map information.

The method may further include automatically selecting at least one tag from the recommendation tag list based on an external input or a predetermined preference or receiving a tag based on an external input.

The method may further include transmitting a tag renewal message including the selected tag or the input tag, the device ID, the content ID, and the additional information, to the tag providing server.

The method may further include transmitting the selected tag or the input tag, the device ID, the content ID, and the multimedia contents, to a contents database (DB) server.

The method may further include storing the content ID and the additional information.

According to an aspect of another exemplary embodiment, there is provided a method of managing a tag, in a tag providing server, the method including: receiving a tag request message including a device ID, a content ID of multimedia content, and additional information regarding the multimedia content, from a mobile device; generating a recommendation tag list based on the received additional information; and transmitting a tag response message including the recommendation tag list to the mobile device.

In the generating of the recommendation tag list, the recommendation tag list may be generated based on a similarity between stored additional information and the received additional information.

The method may further include storing the content ID, the additional information, and the recommendation tag list.

The method may further include receiving a tag renewal message including the device ID, the content ID, the additional information, and the tag selected or input by using the mobile device, from the mobile device.

The method may further include renewing the stored recommendation tag list by using the tag selected or input by using the mobile device.

According to an aspect of another exemplary embodiment, there is provided a computer readable recording medium having embodied thereon a program for executing the above-described method.

According to an aspect of another exemplary embodiment, there is provided a mobile device including: a photographing unit which photographs multimedia content that is identified by a content ID; an additional information obtaining unit which obtains additional information regarding the multimedia content; a tag request message transmitting unit which transmits a tag request message including a device ID, the content ID, and the additional information, to a tag providing server; and a tag response message receiving unit which receives a tag response message including a recommendation tag list from the tag providing server.

According to an aspect of another exemplary embodiment, there is provided a tag providing server including: a tag request message receiving unit which receives a tag request message including a device ID, a content ID of multimedia content, and additional information regarding the multimedia content from a mobile device; a recommendation tag list generating unit which generates a recommendation tag list based on the received additional information; and a tag response message transmitting unit which transmits a tag response message including the recommendation tag list to the mobile device.

According to an aspect of another exemplary embodiment, there is provided a method of managing a tag for multimedia content, the method including: capturing multimedia content; obtaining additional information regarding the multimedia content; transmitting, to a tag providing server, a tag request message comprising the additional information; and receiving, from the tag providing server, a tag response message comprising a recommendation tag list for the multimedia content.

### BRIEF DESCRIPTION OF THE DRAWINGS

The above and other aspects will become more apparent by describing in detail exemplary embodiments with reference to the attached drawings in which:

FIG. 1 illustrates an example of using position information among additional information;

FIG. 2 illustrates an example of using POI map information and direction and position information among additional information according to an exemplary embodiment.

FIG. 3 is a flowchart illustrating a method of managing a tag of multimedia contents, according to an exemplary embodiment;

FIG. 4 is a flowchart illustrating a method of managing a tag of a mobile device, according to an exemplary embodiment;

FIG. 5 is a flowchart illustrating a method of managing a tag of a tag providing server, according to an exemplary embodiment;

FIG. 6 is a schematic view of a mobile device according to an exemplary embodiment; and

FIG. 7 is a schematic view of a tag providing server according to an exemplary embodiment.

### DETAILED DESCRIPTION OF EXEMPLARY EMBODIMENTS

Exemplary embodiments will now be described more fully with reference to the accompanying drawings, in which like reference numerals in the drawings denote like elements. In the drawings, the thicknesses of layers and regions may be exaggerated for clarity. Furthermore, expressions such as “at least one of,” when preceding a list of elements, modify the entire list of elements and do not modify the individual elements of the list.

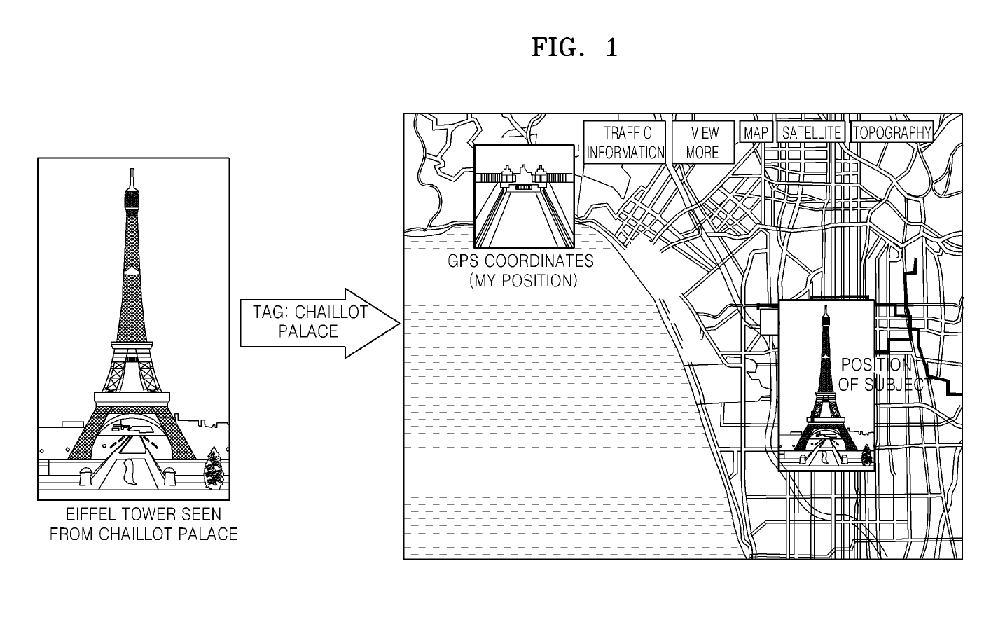

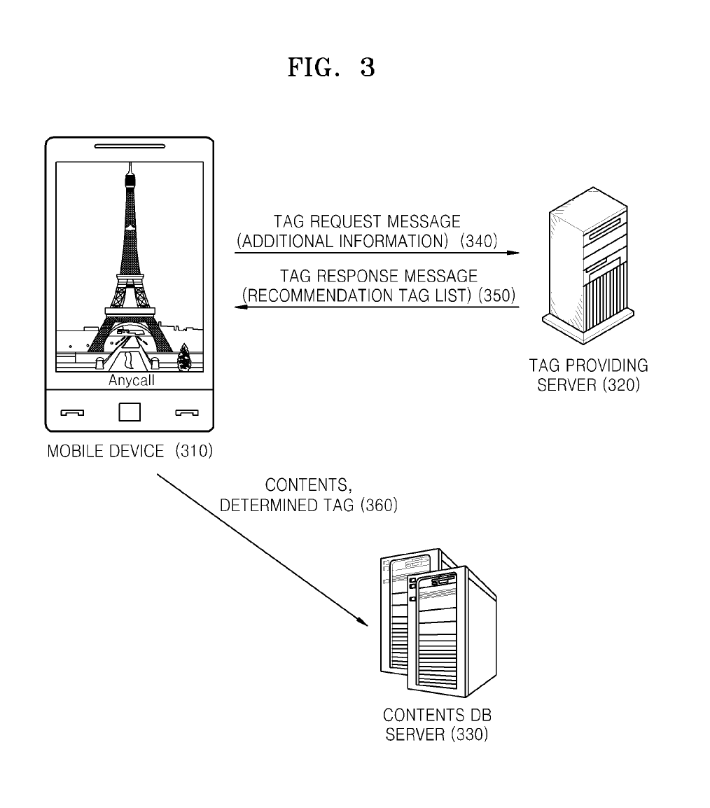

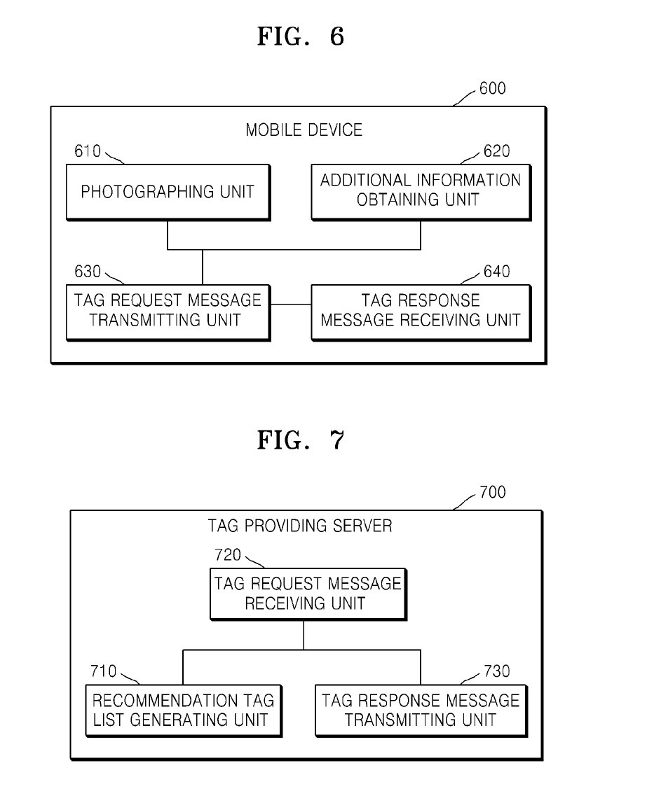

FIG. 1 illustrates an example of using position information among additional information. Referring to FIG. 1, when a user photographs, from example, the Eiffel Tower from Chaillot Palace by using a mobile device 310 (see FIG. 3) or 600 (see FIG. 6) that includes a position information providing unit which provides position information, such as a global positioning system (GPS), position information such as GPS coordinates provided by the position information providing unit is automatically registered to a tag. Accordingly, the user does not have to additionally input a tag and may share position information with other users.

However, when the position information providing unit is included in the mobile device 310 or 600, the position information providing unit provides a position of the mobile device 310 or the mobile device 600 instead of a position of the Eiffel Tower which is the subject being photographed. Thus, if other additional information is not used, accuracy of information regarding a captured image may be decreased for the use of the tag.

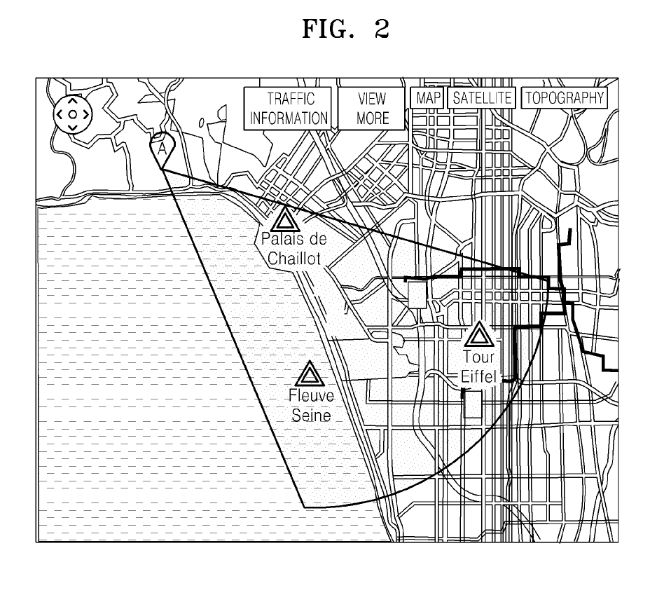

FIG. 2 illustrates an example of using point of interest (POI) map information, a direction, and position information of a subject among additional information according to an exemplary embodiment. Referring to FIGS. 2, 3, and 6, a mobile device 310 or 600 according to an exemplary embodiment includes a photographing unit 610 and an additional information obtaining unit 620. The additional information obtaining unit 620 may include at least one of a position information providing unit (not shown), a direction information providing unit (not shown), an altitude information providing unit (not shown), and an acceleration sensor unit (not shown).

The mobile device 310 or 600 may obtain additional information such as photographing time, angle of view, and a focal distance from the photographing unit 610.

Also, the mobile device 310 or 600 may obtain at least one of position information such as GPS information and POI map information of a subject from the position information providing unit (not shown), a direction of a subject from the direction information providing unit (not shown), and an altitude of a subject from the altitude information providing unit (not shown). For example, the direction information providing unit (not shown) may operate as a compass, and the altitude information providing unit (not shown) may operate as an altimeter.

Also, the mobile device 310 or 600 may obtain additional information including acceleration and inclination of a subject from the acceleration sensor unit (not shown).

Referring to FIG. 2, map and POI map information obtained from the position information providing unit (not shown) and a direction obtained from the direction information providing unit (not shown) are used as additional information.

FIG. 3 is a flowchart illustrating a method of managing a tag of multimedia contents, according to an exemplary embodiment. Referring to FIGS. 3, 6, and 7, the mobile device 310 or 600 that is identified by a unique device ID photographs multimedia contents. Furthermore, the mobile device 310 or 600 generates contents ID for identifying the multimedia contents. When the mobile device 310 or 600 records a video, several contents IDs regarding the same multimedia contents may be generated over time.

The mobile device 310 or 600 obtains additional information regarding multimedia contents. As described above, the mobile device 310 or 600 may obtain additional information including, for example, at least one of photographing time, position information, angle of view, focal distance, direction, altitude, acceleration, inclination, and POI map information.

The mobile device 310 or 600 transmits a tag request message that includes at least one of the additional information, etc. to a tag providing server 320 or 700 in operation 340.

The tag providing server 320 or 700 generates a recommendation tag list based on the received additional information. For example, the tag providing server 320 or 700 generates a recommendation tag list based on a similarity between previously stored additional information and the received additional information. The tag providing server 320 or 700 may store at least one of contents ID, additional information, the recommendation tag list, etc.

In operation 350, the tag providing server 320 or 700 transmits a tag response message that includes the recommendation tag list to the mobile device 310 or 600 in response to the tag request message.

The mobile device 310 or 600 may automatically select at least one tag from the recommendation tag list based on an external input or predetermined preference. Also, the mobile device 310 or 600 may receive a tag based on an external input.

In one or more exemplary embodiments, the mobile device 310 or 600 may transmit a tag renewal message including at least one of the selected or input tag and additional information to the tag providing server 320 or 700. The tag providing server 320 or 700 that has received the tag renewal message may renew or update the stored recommendation tag list by using the selected or input tag.

The mobile device 310 or 600 transmits a tag request message to the tag providing server 320 or 700 when multimedia contents are photographed or at a later time, for example, after information related to the multimedia contents or additional information are stored, with respect to the stored multimedia contents.

Also, the mobile device 310 or 600 may transmit the selected or input tag and multimedia contents to a contents database (DB) server 330 in operation 360.

According to the current exemplary embodiment, the additional information related to multimedia contents, generated by using the mobile device 310 or 600, is transmitted to the tag providing server 320 or 700, and a tag may be recommended from the tag providing server 320 or 700 based on the additional information. Thus, the user may receive a tag related to the multimedia contents simply by selecting the tag related to the multimedia contents. Accordingly, according to the current exemplary embodiment, the user may reduce the effort and time taken to input a tag.

Also, according to the current exemplary embodiment, as the tag selected by the user is accumulated in the tag providing server 320 or 700, accuracy of the tag is increased, and the tag providing server 320 or 700 may provide a more accurate tag to a next user.

Furthermore, according to the current exemplary embodiment, by using various additional information, various position-based augmented reality scenarios, which are difficult to provide based only on conventional GPS information, may be supported.

Also, according to the current exemplary embodiment, multimedia contents and tags may be managed separately in the tag providing server 320 and the contents DB server 330, respectively, and thus various tags may be extracted by using a method of requesting tags regarding the same multimedia contents to the tag providing server 320. Therefore, various tags may be extracted according to application purposes.

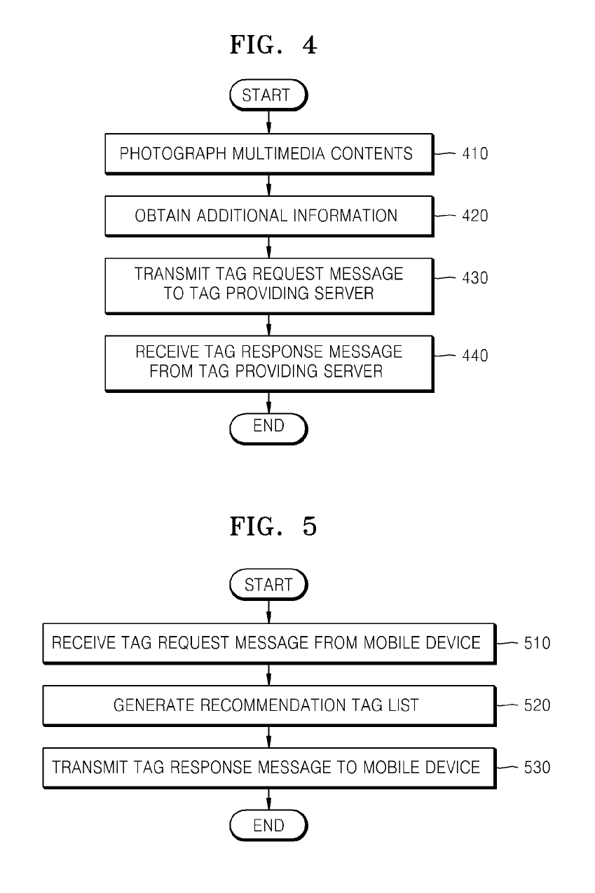

FIG. 4 is a flowchart illustrating a method of managing a tag of a mobile device 310 or 600, according to an exemplary embodiment. Referring to FIG. 4, in operation 410, the mobile device 310 or 600 that is identified by a unique device ID photographs multimedia contents. The mobile device 310 or 600 generates a contents ID for identifying the multimedia contents.

In operation 420, the mobile device 310 or 600 obtains additional information regarding the multimedia contents.

In operation 430, the mobile device 310 or 600 transmits a tag request message including a device ID, the contents ID, and the additional information to the tag providing server 320 or 700. The mobile device 310 or 600 may transmit a tag request message to the tag providing server 320 or 700 when multimedia contents are photographed, or at a later time, for example, after the multimedia contents, a contents ID thereof, and additional information thereof are stored, with respect to the stored multimedia contents.

In operation 440, the mobile device 310 or 600 receives a tag response message including a recommendation tag list from the tag providing server 320 or 700, in response to the tag request message.

The mobile device 310 or 600 may automatically select at least one tag from the recommendation tag list based on an external input or a predetermined preference. Also, the mobile device 310 or 600 may receive a tag based on the external input.

The mobile device 310 or 600 may transmit a tag renewal message including the selected or input tag, the additional information, a device ID, and the contents ID to the tag providing server 320 or 700 so that the tag providing server 320 or 700 renews the stored recommendation tag list.

FIG. 5 is a flowchart illustrating a method of managing a tag of a tag providing server 320 or 700, according to an exemplary embodiment. Referring to FIG. 5, in operation 510, the tag providing server 320 or 700 receives a tag request message that includes a device ID, a contents ID, and additional information of multimedia contents from the mobile device 310 or 600.

In operation 520, the tag providing server 320 or 700 generates a recommendation tag list based on the received additional information. For example, the tag providing server 320 or 700 generates a recommendation tag list based on a similarity between previously stored additional information and the received additional information.

In operation 530, the tag providing server 320 or 700 transmits a tag response message including the recommendation tag list to the mobile device 310 or 600 in response to a tag request message.

The tag providing server 320 or 700 may receive a tag renewal message that includes the selected or input tag, the additional information, the device ID, and the contents ID from the mobile device 310 or 600. The tag providing server 320 or 700 may use the selected or input tag, or the like to renew the stored recommendation tag list.

FIG. 6 is a schematic view of a mobile device 310 or 600 according to an exemplary embodiment. Referring to FIG. 6, the mobile device 310 or 600 includes a photographing unit 610, an additional information obtaining unit 620, a tag request message transmitting unit 630, and a tag response message receiving unit 640.

The photographing unit 610 photographs multimedia contents that are identified by a contents ID.

The additional information obtaining unit 620 obtains additional information regarding the multimedia contents. The additional information obtaining unit 620 may include at least one of a position information providing unit (not shown), a direction information providing unit (not shown), an altitude information providing unit (not shown), an acceleration sensor unit (not shown), and the like.

The additional information obtaining unit 620 may obtain at least one additional information selected from at least one of photographing time, position information, angle of view, focal distance, direction, altitude, acceleration, inclination, point of interest (POI) map information, etc.

For example, the additional information obtaining unit 620 may obtain photographing time, angle of view, and focal distance from the photographing unit 610. Also, the additional information obtaining unit 620 may obtain position information such as GPS information, POI map information, etc., from the position information providing unit (not shown), directions from the direction information providing unit (not shown), and altitude from the altitude information providing unit (not shown). The direction information providing unit may operate as a compass, and the altitude information providing unit may operate as an altimeter. Also, the additional information obtaining unit 620 may obtain acceleration and inclination by using the acceleration sensor unit (not shown).

The tag request message transmitting unit 630 transmits a tag request message including a device ID, a contents ID, and additional information of the multimedia contents to the tag providing server 320 or 700.

The tag request message transmitting unit 630 may transmit a tag request message after photographing multimedia contents or at a later time, for example, after information related to the multimedia contents and additional information are stored.

The tag response message receiving unit 640 receives a tag response message including a recommendation tag list from the tag providing server 320 or 700.

The mobile device 310 or 600 may further include at least one of a tag determining unit (not shown), a tag renewal message transmitting unit (not shown), a storage unit (not shown), and a contents transmitting unit (not shown).

The tag determining unit (not shown) automatically selects at least one tag from the recommendation tag list based on an external input or predetermined preference or receives a tag based on an external input.

The tag renewal message transmitting unit (not shown) transmits a tag renewal message including a selected or input tag, a device ID, a contents ID, and additional information to the tag providing server 320 or 700.

The storage unit (not shown) stores the contents ID and the additional information. For example, the storage unit (not shown) may be external or internal, and may be a volatile memory (such as RAM) or a non-volatile memory (such as ROM, flash memory, or a hard disk drive). Furthermore, the storage unit (not shown) may be an external storage device.

The contents transmitting unit (not shown) transmits the selected or input tag, the device ID, the contents ID, or multimedia contents to the contents DB server 330.

FIG. 7 is a schematic view of a tag providing server 320 or 700 according to an exemplary embodiment. Referring to FIG. 7, the tag providing server 320 or 700 includes a tag request message receiving unit 710, a recommendation tag list generating unit 720, and a tag response message transmitting unit 730.

The tag request message receiving unit 710 receives a tag request message including a device ID, a contents ID of multimedia contents, and additional information regarding the multimedia contents, from the mobile device 310 or 600, or any type of external device storing or capturing the multimedia contents.

The recommendation tag list generating unit 720 generates a recommendation tag list based on the received additional information. For example, the recommendation tag list generating unit 720 may generate the recommendation tag list based on a similarity between previously stored additional information and the received additional information.

The tag response message transmitting unit 730 transmits a tag response message including the recommendation tag list to the mobile device 310 or 600.

The tag providing server 320 or 700 may further include at least one of a storage unit (not shown), a tag renewal message receiving unit (not shown), and a renewal unit (not shown).

The storage unit stores the contents ID, the additional information, and the recommendation tag list. For example, the storage unit (not shown) may be external or internal, and may be a volatile memory (such as RAM) or a non-volatile memory (such as ROM, flash memory, or a hard disk drive). Furthermore, the storage unit (not shown) may be an external storage device.

The tag renewal message receiving unit (not shown) receives a tag renewal message including a device ID, a contents ID, additional information, and a tag selected or input by using the mobile device 310 or 600, from the mobile device 310 or 600.

The renewal unit (not shown) renews the stored recommendation tag list by using a tag that is selected or input by using the mobile device 310 or 600.

While exemplary embodiments have been particularly shown and described with reference to the drawings, it will be understood by those of ordinary skill in the art that various changes in form and details may be made therein without departing from the spirit and scope of the present inventive concept as defined by the following claims.

For example, the mobile device 600 and the tag providing server 700 according to one or more exemplary embodiments may include a bus coupled to each unit thereof and at least one processor coupled to the bus, as illustrated in FIGS. 6 and 7, and a memory that is coupled to the bus to store a command, a received message or a generated message, and that is also coupled to the at least one processor to execute commands as described above.

Furthermore, while the above exemplary embodiments are described with relation to photographing multimedia content, it is understood that another exemplary embodiment is not limited thereto. For example, according to another exemplary embodiment, the multimedia content may be captured or stored content.

Exemplary embodiments can also be embodied as computer readable codes on a computer readable recording medium. The computer readable recording medium is any data storage device that can store data which can be thereafter read by a computer system. Examples of the computer readable recording medium include magnetic storage media such as read-only memory (ROM), floppy disks, hard disks, optical readable media such as CD-ROMs, DVDs, etc. The computer readable recording medium can also be distributed over network coupled computer systems so that the computer readable code is stored and executed in a distributed fashion.

What is claimed is:

1. A method of managing, in a mobile device, a tag for multimedia content, the method comprising:
photographing the multimedia content that is identified by a content identifier (ID);
obtaining additional information regarding the multimedia content;
transmitting, to a tag providing server, a tag request message comprising a device ID of the mobile device, the content ID, and the additional information; and
receiving, from the tag providing server, a tag response message comprising a recommendation tag list.

2. The method of claim 1, wherein the additional information comprises at least one of photographing time, position information, angle of view, focal distance, direction, altitude, acceleration, inclination, and point of interest (POI) map information.

3. The method of claim 1, further comprising selecting at least one tag from the recommendation tag list based on an external input or a predetermined preference or receiving a tag based on an external input.

4. The method of claim 3, further comprising transmitting, to the tag providing server, a tag renewal message comprising the selected tag or the received tag, the device ID, the content ID, and the additional information.

5. The method of claim 3, further comprising transmitting, to a contents database (DB) server distinct from the tag providing server, the selected tag or the received tag, the device ID, the content ID, and the multimedia content.

6. The method of claim 1, further comprising storing the content ID and the additional information.

7. A method of managing, in a tag providing server, a tag for multimedia content, the method comprising:
receiving, from an external device, a tag request message comprising a device ID of the device, a content ID of the multimedia content, and additional information regarding the multimedia content;
generating a recommendation tag list based on the received additional information; and
transmitting, to the external device, a tag response message comprising the recommendation tag list.

8. The method of claim 7, wherein the generating the recommendation tag list comprises generating the recommendation tag list based on a similarity between stored additional information and the received additional information.

9. The method of claim 7, further comprising storing the content ID, the additional information, and the recommendation tag list.

10. The method of claim 7, further comprising receiving, from the external device, a tag renewal message comprising the device ID, the content ID, the additional information, and a tag selected from the recommendation tag list or input through the external device.

11. The method of claim 10, further comprising:
storing the recommendation tag list; and
renewing the stored recommendation tag list by using the tag selected from the recommendation tag list or input through the external device.

12. The method of claim 7, wherein the external device is a mobile device.

13. The method of claim 7, wherein the multimedia content is captured by the external device.

14. A mobile device comprising:
a photographing unit which photographs multimedia content that is identified by a content identifier (ID);
an additional information obtaining unit which obtains additional information regarding the multimedia content;
a tag request message transmitting unit which transmits, to a tag providing server, a tag request message comprising a device ID of the mobile device, the content ID, and the additional information; and
a tag response message receiving unit which receives, from the tag providing server, a tag response message comprising a recommendation tag list.

15. The mobile device of claim 14, wherein the additional information comprises at least of photographing time, position information, angle of view, focal distance, direction, altitude, acceleration, inclination, and point of interest (POI) map information.

16. The mobile device of claim 14, further comprising a tag determining unit which selects at least one tag from the recommendation tag list based on an external input or a predetermined preference or receives a tag based on an external input.

17. The mobile device of claim 16, further comprising a tag renewal message transmitting unit which transmits, to the tag providing server, a tag renewal message comprising the selected tag or the received tag, the device ID, the content ID, and the additional information.

18. The mobile device of claim 16, further comprising a contents transmitting unit which transmits, to a contents database (DB) server distinct from the tag providing server, the selected tag or the received tag, the device ID, the content ID, and the multimedia content.

19. The mobile device of claim 14, further comprising a storage unit which stores the content ID and the additional information.

20. A tag providing server comprising:
a tag request message receiving unit which receives, from an external device, a tag request message comprising a device ID of the external device, a content ID of multimedia content, and additional information regarding the multimedia content;
a recommendation tag list generating unit which generates a recommendation tag list based on the received additional information; and
a tag response message transmitting unit which transmits, to the external device, a tag response message comprising the recommendation tag list.

21. The tag providing server of claim 20, wherein the recommendation tag list generating unit generates the recommendation tag list based on a similarity between stored additional information and the received additional information.

22. The tag providing server of claim 20, further comprising a storage unit which stores the content ID, the additional information, and the recommendation tag list.

23. The tag providing server of claim 20, further comprising a tag renewal message receiving unit which receives, from the external device, a tag renewal message comprising the device ID, the content ID, the additional information, and a tag selected from the recommendation tag list or input through the external device

24. The tag providing server of claim 23, further comprising:
a storage unit which stores the recommendation tag list; and
a renewing unit which renews the stored recommendation tag list by using the tag selected from the recommendation tag list or input through the external device.

25. The tag providing server of claim 20, wherein the external device is a mobile device.

26. A method of managing a tag for multimedia content, the method comprising:
capturing multimedia content;
obtaining additional information regarding the multimedia content;
transmitting, to a tag providing server, a tag request message comprising the additional information; and
receiving, from the tag providing server, a tag response message comprising a recommendation tag list for the multimedia content.

27. A computer readable recording medium having embodied thereon a program for executing the method of claim 1.

28. A computer readable recording medium having embodied thereon a program for executing the method of claim 7.

29. A computer readable recording medium having embodied thereon a program for executing the method of claim 26.
